(19) United States
(12) Patent Application Publication
(10) Pub. No.: US 2022/0321207 A1
(43) Pub. Date: Oct. 6, 2022

(54) MEASUREMENT CONFIGURATION IN NON-TERRESTRIAL NETWORKS

(71) Applicant: QUALCOMM Incorporated, San Diego, CA (US)

(72) Inventors: Changhwan PARK, San Diego, CA (US); Xiao Feng WANG, San Diego, CA (US); Bharat SHRESTHA, San Diego, CA (US); Qunfeng HE, San Diego, CA (US); Carlos CABRERA MERCADER, Cardiff, CA (US); Valentin Alexandru GHEORGHIU, Tokyo (JP); Liangping MA, San Diego, CA (US)

(21) Appl. No.: 17/457,542

(22) Filed: Dec. 3, 2021

Related U.S. Application Data
(60) Provisional application No. 63/200,971, filed on Apr. 6, 2021.

(51) Int. Cl. H04B 7/185; H04L 5/00; H04W 24/10; H04W 48/16; H04W 56/00

(52) U.S. Cl. CPC H04B 7/18519; H04L 5/0051; H04W 24/10; H04W 48/16; H04W 56/0055

(57) ABSTRACT

Various aspects of the present disclosure generally relate to wireless communication. In some aspects, a user equipment (UE) may receive, from a source node in a non-terrestrial network (NTN) providing an NTN cell, measurement reference information regarding one or more measurements, wherein the measurement reference information includes association information including a group identifier for the one or more measurements. The UE may communicate in the NTN cell in accordance with the measurement reference information. Numerous other aspects are described.

### CROSS-REFERENCE TO RELATED APPLICATION

This Patent Application claims priority to U.S. Provisional Patent Application No. 63/200,971, filed on Apr. 6, 2021, entitled “MEASUREMENT CONFIGURATION IN NON-TERRESTRIAL NETWORKS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for measurement configuration in non-terrestrial networks (NTNs).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving, from a source node in a non-terrestrial network (NTN) providing an NTN cell, measurement reference information regarding one or more measurements, wherein the measurement reference information includes association information including a group identifier for the one or more measurements; and communicating in the NTN cell in accordance with the measurement reference information.

In some aspects, a method of wireless communication performed by a UE includes receiving, from a source node in an NTN providing an NTN cell, a request to provide timing information, wherein the timing information includes system frame number (SFN) or system frame timing difference (SFTD) information and includes time stamp information; and communicating in the NTN cell in accordance with the timing information.

In some aspects, a method of wireless communication performed by a UE includes performing, in an NTN providing an NTN cell, an inter-satellite cell measurement in a radio resource control (RRC) idle or inactive mode; and transmitting a report of the inter-satellite cell measurement in connection with a transition to an RRC connected mode.

In some aspects, a UE for wireless communication includes a memory, and one or more processors, coupled to the memory, configured to: receive, from a source node in an NTN providing an NTN cell, measurement reference information regarding one or more measurements, wherein the measurement reference information includes association information including a group identifier for the one or more measurements; and communicate in the NTN cell in accordance with the measurement reference information.

In some aspects, a UE for wireless communication includes a memory, and one or more processors, coupled to the memory, configured to: receive, from a source node in an NTN providing an NTN cell, a request to provide timing information, wherein the timing information includes SFTD information and includes time stamp information; and communicate in the NTN cell in accordance with the timing information.

In some aspects, a UE for wireless communication includes a memory, and one or more processors, coupled to the memory, configured to: perform, in an NTN providing an NTN cell, an inter-satellite cell measurement in a RRC idle or inactive mode; and transmit a report of the inter-satellite cell measurement in connection with a transition to an RRC connected mode.

In some aspects, a non-transitory computer-readable medium storing a set of instructions for wireless communication includes one or more instructions that, when executed by one or more processors of a UE, cause the UE to: receive, from a source node in an NTN providing an NTN cell, measurement reference information regarding one or more measurements, wherein the measurement reference information includes association information including a group identifier for the one or more measurements; and communicate in the NTN cell in accordance with the measurement reference information.

In some aspects, a non-transitory computer-readable medium storing a set of instructions for wireless communication includes one or more instructions that, when executed by one or more processors of an UE, cause the UE to: receive, from a source node in an NTN providing an NTN cell, a request to provide timing information, wherein the timing information includes SFTD information and includes time stamp information; and communicate in the NTN cell in accordance with the timing information.

In some aspects, a non-transitory computer-readable medium storing a set of instructions for wireless communication includes one or more instructions that, when executed by one or more processors of an UE, cause the UE to: perform, in an NTN providing an NTN cell, an inter-satellite cell measurement in a RRC idle or inactive mode; and transmit a report of the inter-satellite cell measurement in connection with a transition to an RRC connected mode.

In some aspects, an apparatus for wireless communication includes means for receiving, from a source node in an NTN providing an NTN cell, measurement reference information regarding one or more measurements, wherein the measurement reference information includes association information including a group identifier for the one or more measurements; and means for communicating in the NTN cell in accordance with the measurement reference information.

In some aspects, an apparatus for wireless communication includes means for receiving, from a source node in an NTN providing an NTN cell, a request to provide timing information, wherein the timing information includes SFTD information and includes time stamp information; and means for communicating in the NTN cell in accordance with the timing information.

In some aspects, an apparatus for wireless communication includes means for performing, in an NTN providing an NTN cell, an inter-satellite cell measurement in connection with a transition to an RRC idle or inactive mode; and means for transmitting a report of the inter-satellite cell measurement in connection with a transition to an RRC connected mode.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of satellite deployments in a non-terrestrial network (NTN), in accordance with the present disclosure.

FIGS. 4A-4B, 5A-5B, and 6A-6B are diagrams illustrating examples associated with measurement in NTN deployments, in accordance with the present disclosure.

FIGS. 7-9 are diagrams illustrating example processes associated with measurement configuration in NTNs, in accordance with the present disclosure.

FIGS. 10-11 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

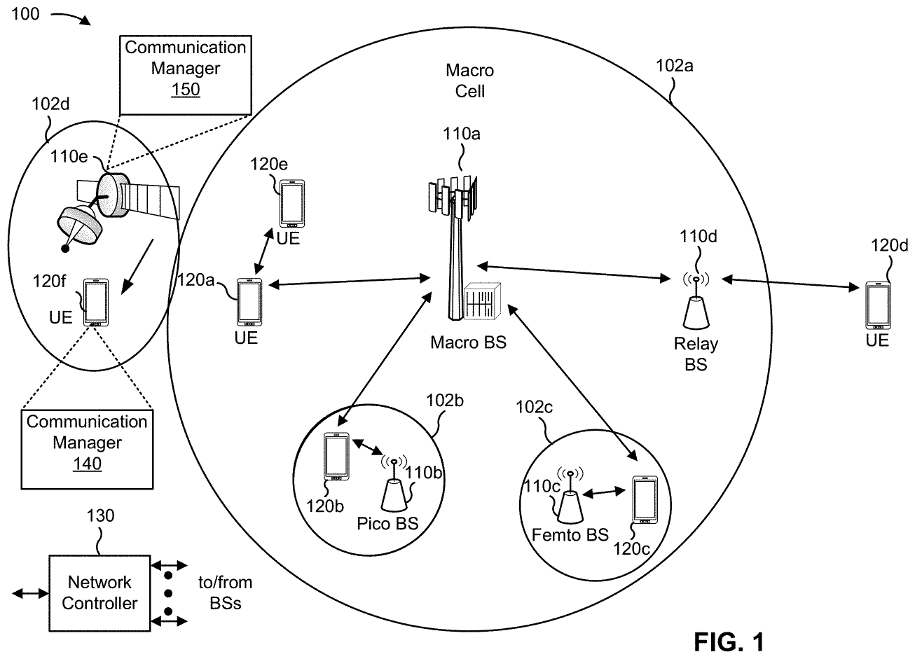

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

In some aspects, wireless network 100 may include satellites that provide cells of wireless network 100. For example, a satellite 110e may provide a cell 102d, which provides coverage for a UE 120f. In some aspects, satellite 110e may be a distributed unit (DU) of BS 110a and provide a portion of coverage (e.g., one or more cells) for BS 110a.

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a source node in a non-terrestrial network (NTN) providing an NTN cell, measurement reference information regarding one or more measurements, wherein the measurement reference information includes association information including a group identifier for the one or more measurements; and communicate in the NTN cell in accordance with the measurement reference information. Additionally, or alternatively, the communication manager 140 may perform one or more other operations described herein.

In some aspects, the satellite 110e may include a communication manager 150. As described in more detail elsewhere herein, the communication manager 150 may communicate with a UE and provide a cell for the UE to obtain access to a network. Additionally, or alternatively, the communication manager 150 may perform one or more other operations described herein.

As indicated above, FIG. 1 is provided as an example. Other examples may differ from what is described with regard to FIG. 1.

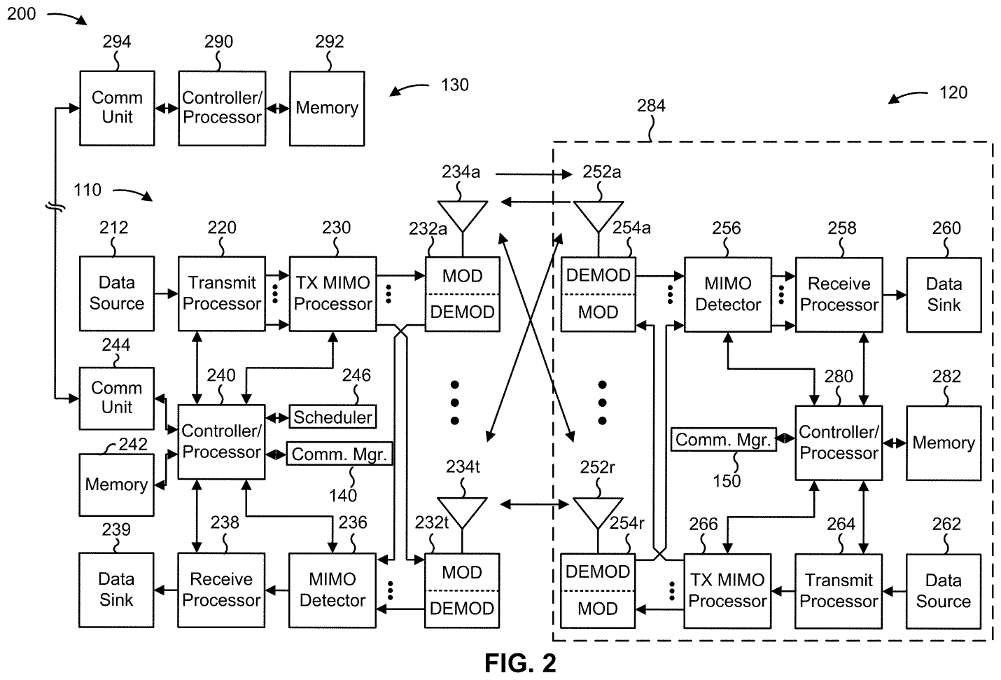

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

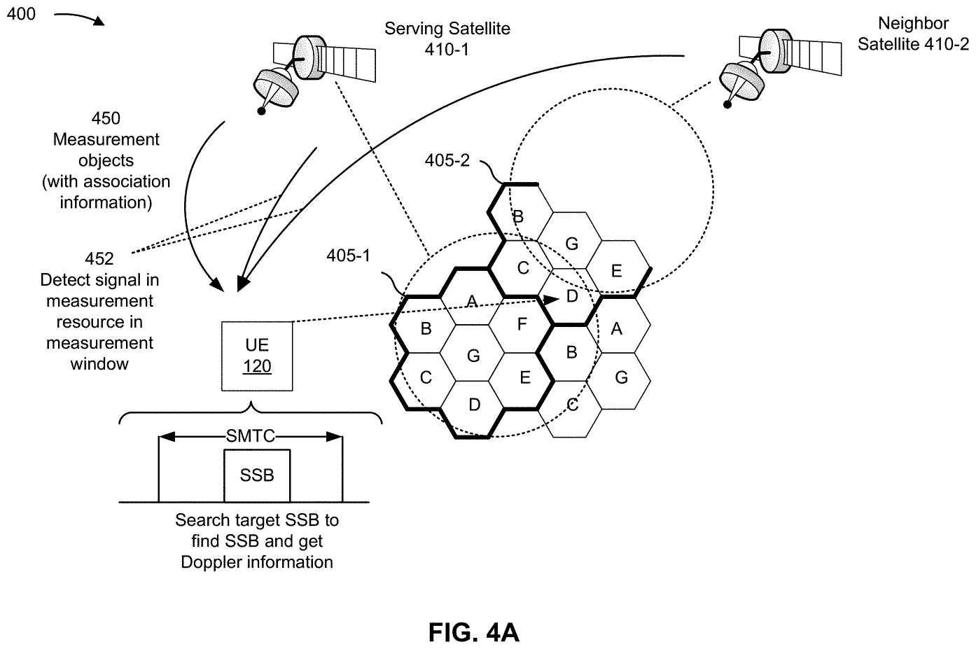

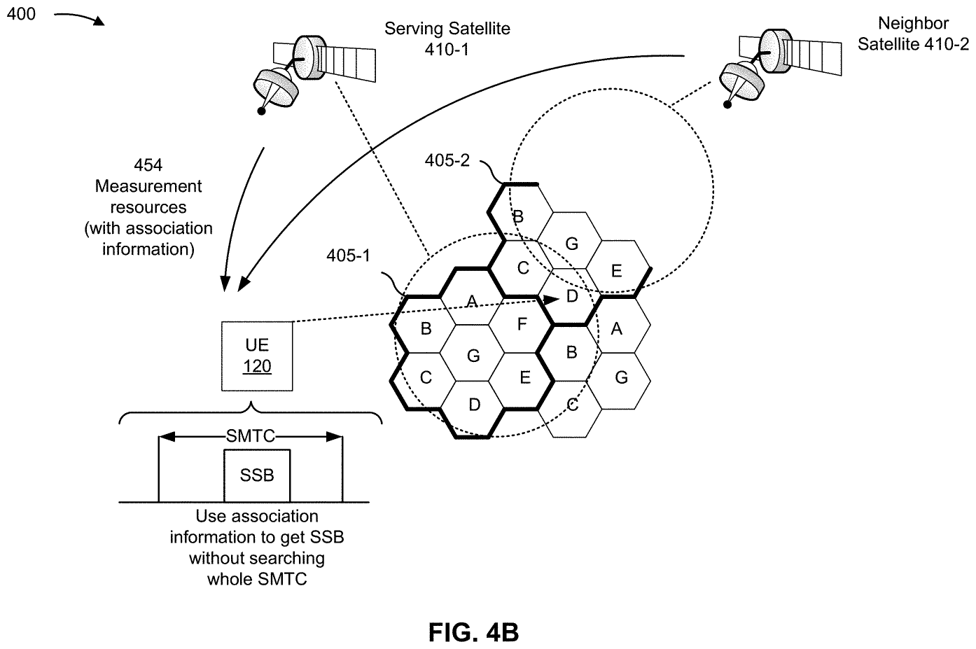

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4A-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4A-11).

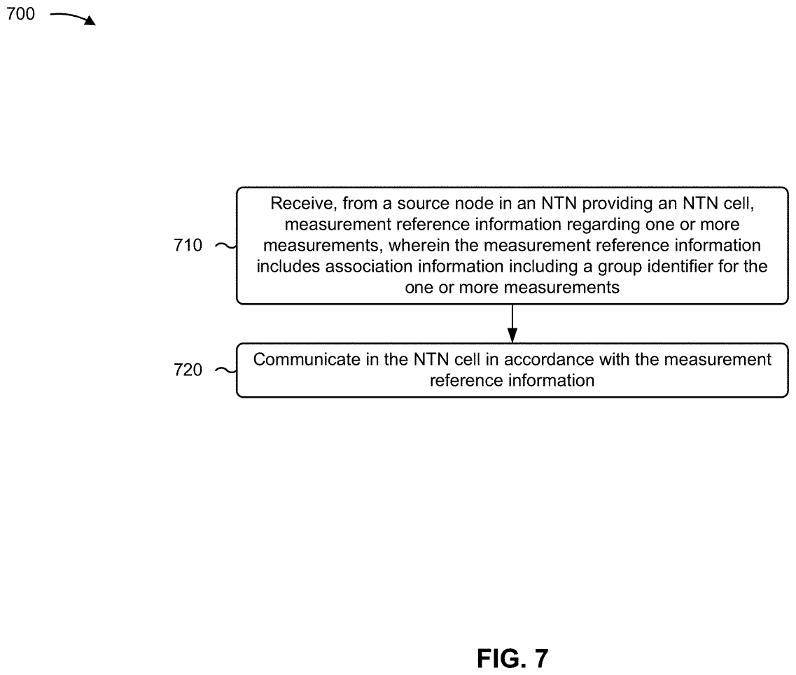

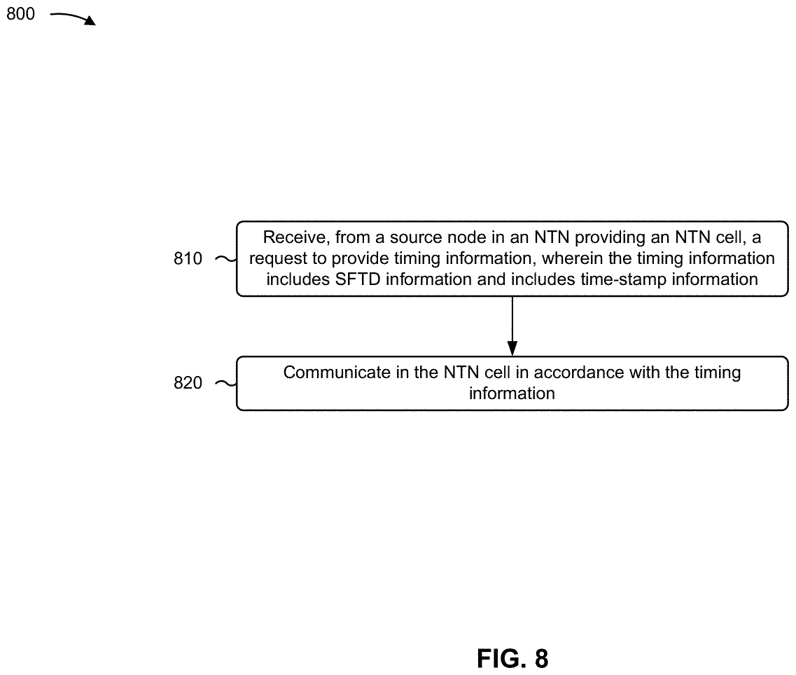

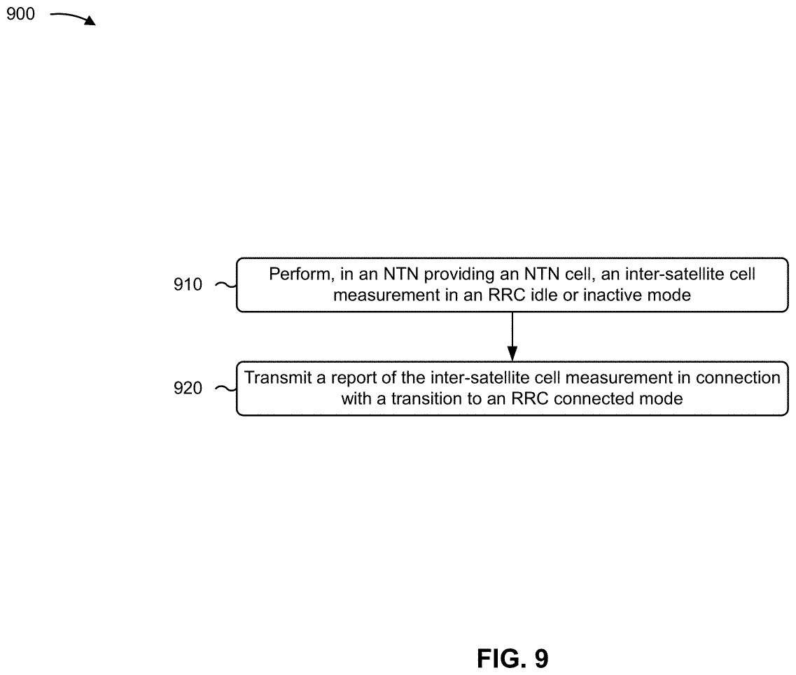

The controller/processor 240 of the base station 110, the controller/processor 280 of the UE 120, and/or any other component(s) of FIG. 2 may perform one or more techniques associated with measurement configuration in non-terrestrial networks (NTNs), as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, process 900 of FIG. 9, and/or other processes as described herein. The memory 242 and the memory 282 may store data and program codes for the base station 110 and the UE 120, respectively. In some aspects, the satellite or satellite node described herein is the base station 110, is included in the base station 110, or includes one or more components of the base station 110 shown in FIG. 2. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving, from a source node in an NTN providing an NTN cell, measurement reference information regarding one or more measurements, wherein the measurement reference information includes association information including a group identifier for the one or more measurements; and/or means for communicating in the NTN cell in accordance with the measurement reference information. In some aspects, the UE 120 includes means for receiving, from a source node in a NTN providing an NTN cell, a request to provide timing information, wherein the timing information includes system frame number (SFN) and/or system frame timing difference (SFTD) information and includes time stamp information; and/or means for communicating in the NTN cell in accordance with the timing information. In some aspects, the UE includes means for performing, in an NTN providing an NTN cell, an inter-satellite cell measurement in a radio resource control (RRC) idle or inactive mode; and/or means for transmitting a report of the inter-satellite cell measurement in connection with a transition to an RRC connected mode. The means for the UE 120 to perform operations described herein may include, for example, one or more of antenna 252, demodulator 254, MIMO detector 256, receive processor 258, transmit processor 264, TX MIMO processor 266, modulator 254, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

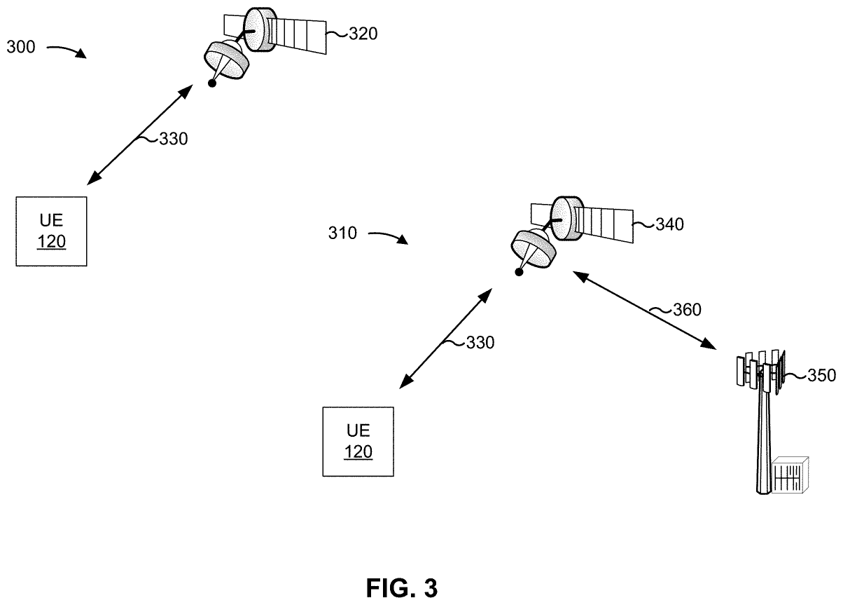

FIG. 3 is a diagram illustrating an example 300 of a regenerative satellite deployment and an example 310 of a transparent satellite deployment in a non-terrestrial network.

Example 300 shows a regenerative satellite deployment in an NTN. In example 300, a UE 120 is served by a satellite 320 via a service link 330. For example, the satellite 320 may include a BS 110 (e.g., BS 110a) or a gNB. In some aspects, the satellite 320 may be referred to as a non-terrestrial base station, a regenerative repeater, or an on-board processing repeater. In some aspects, the satellite 320 may demodulate an uplink radio frequency signal and may modulate a baseband signal derived from the uplink radio signal to produce a downlink radio frequency transmission. The satellite 320 may transmit the downlink radio frequency signal on the service link 330. The satellite 320 may provide a cell that covers the UE 120.

Example 310 shows a transparent satellite deployment, which may also be referred to as a bent-pipe satellite deployment. In example 310, a UE 120 is served by a satellite 340 via the service link 330. The satellite 340 may be a transparent satellite. The satellite 340 may relay a signal received from gateway 350 via a feeder link 360. For example, the satellite may receive an uplink radio frequency transmission and may transmit a downlink radio frequency transmission without demodulating the uplink radio frequency transmission. In some aspects, the satellite may frequency convert the uplink radio frequency transmission received on the service link 330 to a frequency of the uplink radio frequency transmission on the feeder link 360 and may amplify and/or filter the uplink radio frequency transmission. In some aspects, the UEs 120 shown in example 300 and example 310 may be associated with a Global Navigation Satellite System (GNSS) capability or a Global Positioning System (GPS) capability, though not all UEs have such capabilities. The satellite 340 may provide a cell that covers the UE 120.

The service link 330 may include a link between the satellite 340 and the UE 120 and may include one or more of an uplink or a downlink The feeder link 360 may include a link between the satellite 340 and the gateway 350 and may include one or more of an uplink (e.g., from the UE 120 to the gateway 350) or a downlink (e.g., from the gateway 350 to the UE 120).

The feeder link 360 and the service link 330 may each experience Doppler effects due to the movement of the satellites 320 and 340, and potentially movement of a UE 120. These Doppler effects may be significantly larger than in a terrestrial network. The Doppler effect on the feeder link 360 may be compensated for to some degree, but may still be associated with some amount of uncompensated frequency error. Furthermore, the gateway 350 may be associated with a residual frequency error, and/or the satellite 320/340 may be associated with an on-board frequency error. These sources of frequency error may cause a received downlink frequency at the UE 120 to drift from a target downlink frequency.

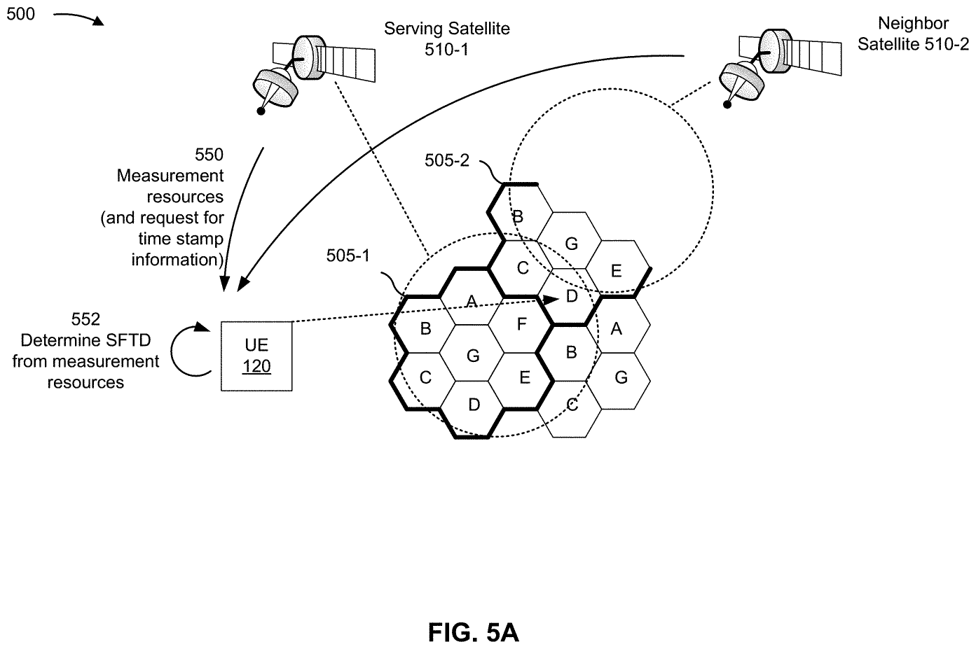

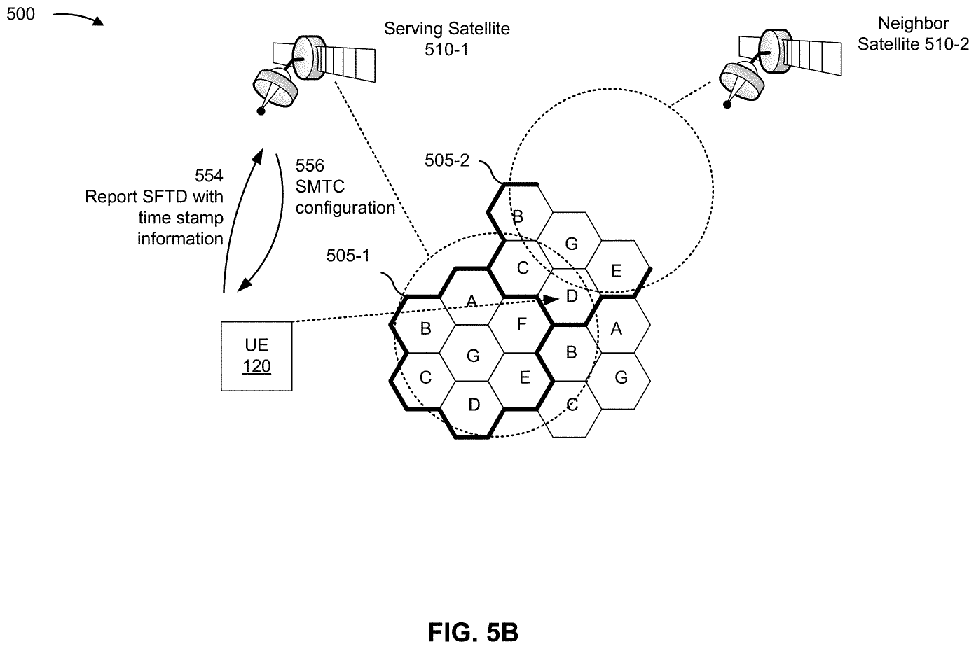

A satellite deployment may include both the satellite 340 and a base station 110 in communication with the UE 120. For example, in a multi-connectivity situation, the UE 120 may be in a coverage area of a first set of cells provided by the satellite 340 and a second set of cells provided by the base station 110. In this case, the UE 120 may perform a set of measurements of signals from the satellite 340 and the base station 110 for operation in an RRC inactive mode or RRC idle mode. In another example, the UE may be in a coverage area of a first set of cells provided by a first satellite 340 and a second set of cells provided by a second satellite 340. In this case, the UE 120 may perform a set of measurements of signals from a first satellite and a second satellite for an RRC connected mode as well as an RRC inactive mode or RRC idle mode. Additional details regarding such deployments may be found in 3GPP Technical Specification (TS) 38.821 version 16.0.0, FIG. 5.3.2.1, among other places.

A communication system that includes one or more satellites 340 may configure measurement windows during which the UE 120 may perform measurements of signals For example, when a first satellite 340 is a serving satellite, the first satellite 340 may identify, to the UE 120, a synchronization signal (SS)/physical broadcast channel (PBCH) block measurement timing configuration (SMTC) including first set of resources scheduled for use and a second set of resources not scheduled for use. The second set of resources may include a configured measurement window during which the UE 120 may perform measurements of signals from a second satellite 340. From a perspective of, for example, gateway 350, the configured measurement window may be aligned, in time, with a synchronization signal block (SSB) window of the second satellite 340, thereby enabling UE 120 to perform measurements of the second satellite 340 when the first satellite 340 is not using resources for communication with the UE 120.

Each satellite may provide groups of cells with a quantity of cells corresponding to a frequency reuse factor (FRF). Each cell, in a group of cells provided by a single satellite 340, may operate at a different center bandwidth to avoid interference. When operating at a center of a group of cells, the UE 120 may only perform neighbor cell measurements of other cells in the group of cells provided by, for example, the first satellite 340. Some neighbor cell measurements include timing measurements that can be used to determine a Doppler synchronization for communication. When the UE 120 performs measurements, the UE 120 may determine a measurement object that includes a cell identifier (Cell-ID), an SSB identifier (SSB-ID). SSBs transmitted by a single satellite and may be time aligned with each other.

At an edge of the group of cells, the UE 120 may have some neighbor cells that are provided by the second satellite 340. Differing signal delays from satellites 340 may result in the SSB window being outside of the configured measurement window for the UE 120. As a result, when the UE 120 attempts to perform a neighbor cell measurement, such as by measuring an SS from the second satellite 340, the UE 120 may fail to receive and decode the SS, thereby resulting in a negative impact to mobility procedures or RRC procedures, among other examples. For satellites in geostationary orbit or geosynchronous equatorial orbit (GEO), the difference in signal delays may be fixed. However, for satellites in non-GEO orbit, such as satellites in low-Earth orbit (LEO), the signal delays may change over time, further resulting in misalignments between measurement windows and signals that are to be measured.

As indicated above, FIG. 3 is provided as an example. Other examples may differ from what is described with regard to FIG. 3.

As described above, establishment of a measurement configuration for UEs being served by multiple satellites or by a satellite and a terrestrial access node (e.g., a ground-based base station) may be complicated by a propagation delay difference between a serving cell that is providing a measurement window and a neighbor cell that is providing a signal for measurement. This propagation delay difference may be unknown to a gateway that is serving the satellites and/or the terrestrial network. Additionally, other factors, such as a UE-specific service link distance or a shift in a propagation delay difference over time, among other examples, may be unknown to the gateway device.

One solution may be to expand a measurement window. For example, by adopting a larger measurement window covering a larger period of time, a likelihood that a signal for measurement is received in the measurement window is increased. However, the increased size of satellite provided cells, as well as the increased distance of the satellite from the cell, may result in a much larger required measurement window to account for propagation delay differences between a center of the cell and an edge of the cell relative to that which occurs in terrestrial networks. As a result, expanding the measurement window may result in excessive network resources being devoted to the measurement window and going unused for control or data transmission.

Some aspects described herein enable timing and frequency (e.g., Doppler information) association between measurement objects. For example, a UE may receive association information identifying an association between timing and frequency (e.g., Doppler shift) information of different measurement objects that have a co-located transmitting source (e.g., a single satellite providing multiple measurement objects). In this case, the association information may include a group identifier (group-ID) included in each measurement object. Based at least in part on the association information, the UE may use a measurement performed on a first measurement object (e.g., associated with a first cell) to identify a timing for performing a measurement on a second measurement object (e.g., associated with a second cell). In this way, a UE may reduce power consumption associated with measurement by leveraging information associated with measuring a first measurement object to perform measurements associated with one or more second measurement objects.

Additionally, when configuring measurement parameters, such as the SMTC, a network control device may use SFN and/or SFTD information between serving cells and target cells. However, changing propagation delay differences may result in SFTD information causing inaccurate SMTC configuration by the network control device. Thus, some aspects described herein enable a UE to report time stamp information associated with SFTD information to enable SMTC configuration.

Additionally, when switching to an RRC connected mode, a network control device may lack timing relation information associated with configuring measurement parameters for a UE. The UE may perform a measurement and provide a measurement report in the RRC connected mode but waiting to perform the measurement may result in excess latency. Thus, some aspects described herein enable a UE to perform a measurement in an RRC idle or RRC inactive mode and report the measurement when switching to an RRC connected mode. In this way, the UE avoids a delay associated with performing a measurement in the RRC connected mode.

FIGS. 4A and 4B are diagrams illustrating an example 400 associated with measurement in NTN deployments, in accordance with the present disclosure. As shown in FIGS. 4A and 4B, example 400 includes a UE 120 operating in FRF coverage areas 405 of a set of satellites 410. In some aspects, satellites 410 and UE 120 may be included in a wireless network, such as wireless network 100. Satellites 410 and UE 120 may communicate via a wireless access link, which may include an uplink and a downlink In some aspects, UE 120 may be in communication with one or more base stations 110 via the one or more satellites 410.

The FRF coverage areas 405 may each have a set of cells associated with different frequencies to avoid interference. For example, a first FRF coverage area 405-1 may include a set of seven cells A through G, each operating at a different frequency band from each other. Similarly, a second FRF coverage area 405-2 may include a set of seven cells A through G, each operating at a different frequency band from each other. Satellites 410 may provide overlapping coverage areas including cells of the FRF coverage areas 405. For example, serving satellite 410-1 may provide coverage for, among other cells, all the cells of first FRF coverage area 405-1 and coverage for cells C and D of second FRF coverage area 405-2. Similarly, neighbor satellite 410-2 may provide coverage for, among other cells, cells B, G, and E of second FRF coverage area 405-2. As shown in FIG. 4A, UE 120 may be operating in cell D of second FRF coverage area 405-2, which may be in the coverage area of serving satellite 410-1 and at an edge of the coverage area of neighbor satellite 410-2.

As further shown in FIG. 4A, and by reference number 450, serving satellite 410-1 may transmit one or more measurement objects. For example, serving satellite 410-1 may transmit a measurement object to UE 120. Additionally, or alternatively, serving satellite 410-1 or another satellite 410 may transmit another type of measurement reference information, such as a broadcasted measurement configuration message associated with an RRC idle or inactive mode to configure multi-cell measurement for mobility. In some aspects, a measurement object may include association information. For example, a satellite 410 may transmit a measurement object that has timing and frequency (e.g., Doppler shift) association information to enable UE 120 to detect measurement resources with the same association information. In some aspects, a serving satellite 410-1 may be a source of the association information. For example, serving satellite 410-1, which may have a particular satellite index, may include identifiers of an association between measurement resources transmitted by serving satellite 410-1 or identifiers of another association between measurement resources transmitted by neighbor satellite 410-2, among other examples.

In some aspects, the association information may include a group identifier. For example, serving satellite 410-1 may include a common group identifier in each measurement object transmitted for each cell. Additionally, or alternatively, serving satellite 410-1 may include a common group identifier in each measurement object for each cell of first FRF coverage area 405-1 or a common group identifier in each measurement object form cells of second FRF coverage area 405-2 provided by satellite 410-1, among other examples. In some aspects, the association information may include a 1 bit indication provided by serving satellite 410-1. For example, serving satellite 410-1 may provide information indicating whether a target measurement cell is different from the serving satellite 410-1. In some aspects, the association information may correspond to a neighbor cell list in a system information block (SIB) (e.g., provided in a UE RRC inactive or idle mode) that includes a per-cell indication of whether a target measurement cell is different from serving satellite 410-1.

Measurement objects with a common group identifier may be quasi-co located and/or synchronized with respect to time resources and/or frequency (e.g., Doppler shift). In some aspects, a measurement object may correspond to a plurality of measurement resources. For example, a measurement object may include measurement resources for one or more SSBs or one or more channel state information reference signals (CSI-RSs), among other examples. In this case, each measurement resource associated with a common measurement object may be quasi-co located with respect to time resources and/or frequency.

In this case, a first one or more sets of measurement resources may be reference sources for a second one or more sets of measurement resources based at least in part on UE detection of the first one or more sets of measurement resources as described in more detail herein. In other words, when UE 120 performs a first measurement, UE 120 can use the first measurement as a reference time or frequency synchronization source for a second measurement. In this way, some aspects provide enhanced flexibility relative to transmission configuration indicator (TCI) signaling, which requires a network to indicate a synchronization source rather than a UE selecting the synchronization source.

In some aspects, serving satellite 410-1 may transmit measurement reference information identifying association information for the measurement objects. For example, serving satellite 410-1 may transmit measurement reference information that indicates that a first set of measurement resources share first association information (e.g., a first group identifier) and that a second set of measurement resources share second association information (e.g., a second group identifier).

As further shown in FIG. 4A, and by reference number 452, UE 120 may a signal (on which to perform a measurement) in a measurement resource of a measurement window. For example, UE 120 may search a target SSB in an SMTC to find an SSB and get Doppler information. In this case, UE 120 may detect an SSB from, for example, serving satellite 410-1 and associated with a particular frequency layer. In some aspects, UE 120 may use a plurality of measurement resources based at least in part on a single measurement object. For example, UE 120 may receive a measurement object identifying one or more SSBs or one or more CSI-RSs, among other examples. In this case, UE 120 may determine that the one or more SSBs and the one or more CSI-RSs are quasi co-located with respect to time resources and/or frequency resources (e.g., Doppler shift). In some aspects, UE 120 may detect a measurement object based at least in part on a frequency list. For example, UE 120 may receive a frequency list in a measurement configuration or a system information message, and the frequency list may identify a set of frequencies used by the same satellite 410. In this case, UE 120 may detect a measurement resource at a particular frequency or frequency layer selected from the set of frequencies.

As further shown in FIG. 4B, and by reference number 454, satellites 410 may transmit one or more subsequent measurement resources. For example, serving satellite 410-1 may transmit another one or more measurement resources that have common association information with a measurement resource detected by UE 120 (e.g., a first common group identifier). Similarly, neighbor satellite 410-2 may transmit another one or more measurement resources that have common association information with a measurement resource detected by UE 120 (e.g., a second common group identifier).

In some aspects, UE 120 may detect a measurement resource in a measurement window using association information. For example, UE 120 may use association information from a first measurement resource detected from serving satellite 410-1 to detect a second measurement resource from serving satellite 410-1. In this case, the first measurement resource and the second measurement resource may share common timing and frequency (e.g., Doppler shift) information.

The first measurement resource, which may be associated with a first frequency layer and a first cell, and the second measurement resource, which may be associated with a second frequency layer and a second cell, may have timing differences less than a maximum reception time difference (MRTD) (e.g., which includes timing alignment error from serving satellite 410-1 and a propagation delay difference) or timing alignment error (TAE) (e.g., which includes the timing alignment error but not the propagation delay difference). However, the timing differences may be less than a total timing difference that can occur in an SMTC. As a result, UE 120 may monitor a smaller portion of the SMTC to detect the second measurement resource than if UE 120 attempted to detect the second measurement resource without using the association information from the first measurement resource. In this way, UE 120 reduces a utilization of power resources relative to attempting to detect a measurement resource without using association information.

In some aspects, UE 120 may use the association information for a particular period of time. For example, UE 120 may receive a first SSB on a first frequency and use association information from a first measurement resource associated with the first SSB to detect one or more second SSBs on one or more second frequencies during the particular period of time. In this case, the particular period of time may be configured based at least in part on an amount of time in which quasi co-location of measurement resources remain valid as a result of movement of satellites 410 or UE 120, among other examples.

As indicated above, FIGS. 4A and 4B are provided as an example. Other examples may differ from what is described with respect to FIGS. 4A and 4B.

FIGS. 5A and 5B are diagram illustrating an example 500 associated with measurement in NTN deployments, in accordance with the present disclosure. As shown in FIGS. 5A and 5B, example 500 includes a UE 120 operating in FRF coverage areas 505 of a set of satellites 510. In some aspects, satellites 510 and UE 120 may be included in a wireless network, such as wireless network 100. Satellites 510 and UE 120 may communicate via a wireless access link, which may include an uplink and a downlink In some aspects, UE 120 may be in communication with one or more base stations 110 via the one or more satellites 510.

As further shown in FIG. 5A, and by reference number 550, satellites 510 may transmit one or more measurement resources. For example, serving satellite 510-1 may transmit a measurement object or measurement configuration at a first time and serving satellite 510-1 and neighbor satellite 510-2 may transmit a measurement resource at a respective second times. In some aspects, satellites 510 may transmit measurement resources associated with a particular set of measurements. For example, satellites 510 may transmit the measurement objects to identify measurement resources for an SSB measurement or a CSI-RS measurement, among other examples. In some aspects, satellites 510 may include a request for UE 120 to perform a time stamp measurement in connection with determining an SFTD value. For example, serving satellite 510-1 may transmit configuration information (e.g., with a measurement object, a measurement configuration, the measurement resources, or via separate configuration signaling) indicating that UE 120 is to perform a time stamp determination in connection with a measurement of an SFTD. In this case, the SFTD may include a measurement of a system frame number and/or system frame timing difference.

As further shown in FIG. 5A, and by reference number 552, UE 120 may determine an SFTD from the measurement resources. For example, UE 120 may determine an SFTD measurement between a serving cell (e.g., of serving satellite 510-1) and a neighbor cell (e.g., of neighbor satellite 510-2 or of a base station 110, among other examples). In some aspects, UE 120 may determine a time stamp associated with the SFTD measurement. For example, UE 120 may record, in connection with a first measurement of a measurement resource from serving satellite 510-1, a first time stamp of when the measurement is performed. Similarly, UE 120 may record, in connection with a second measurement of a measurement resource from neighbor satellite 510-2, a second time stamp of when the second measurement is performed. In some aspects, UE 120 may obtain a particular type of timing information for the time stamp, such as an absolute time or a relative time (e.g., offset from another time, such as relative to a previously reported time stamp).

In some aspects, UE 120 may determine a relative time as an offset from a first time (e.g., a first slot) in which UE 120 performed an SFTD measurement to a second time (e.g., a second slot) in which UE 120 reports the SFTD measurement. In some aspects, UE 120 may determine a set of time indices or instances as the time stamp measurement. For example, when UE 120 receives configuration information indicating that UE 120 is to measure an SFTD at a particular set of occurrences (e.g., a first occurrence at a first time, a second occurrence at a second time, etc.), UE 120 may determine, in connection with an SFTD measurement, to which index or instance the SFTD measurement corresponds. Additionally, or alternatively, UE 120 may determine a time stamp based at least in part on a slot index and the SFTD measurement. For example, UE 120 may determine a first SFTD measurement in which a value satisfies a threshold and may determine a timestamp for a second SFTD measurement as an offset value corresponding to a quantity of slots, indices, or instances, among other examples between the first SFTD measurement and the second SFTD measurement.

As further shown in FIG. 5B, and by reference number 554, UE 120 may report the SFTD. For example, UE 120 may transmit information identifying the SFTD measurement and a time stamp In this case, UE 120 may report a first time stamp associated with a first measurement (e.g., of a first cell) or a second time stamp associated with a second measurement (e.g., of a second cell), among other examples. In some aspects, UE 120 may report an absolute time or a relative time for a time stamp associated with an SFTD. Additionally, or alternatively, UE 120 may report an offset between measuring the SFTD and transmitting the SFTD measurement. Additionally, or alternatively, UE 120 may report an identifier of an index or instance for which UE 120 is configured to perform the SFTD measurement. Additionally, or alternatively, UE 120 may report an identifier of an offset between SFTD measurements.

As further shown in FIG. 5B, and by reference number 556, a satellite 510 may determine and provide an SMTC configuration for UE 120 to use for communication with the satellite 510. For example, the satellite 510 (e.g., serving satellite 510-1) may use the SFTD measurement and the time stamp to determine validity information regarding the SFTD measurement and to optimize an SMTC or a measurement gap (MG). In this case, the satellite 510 (e.g., serving satellite 510-1) may transmit information indicating the SMTC or MG and UE 120, and the satellite 510 may communicate (e.g., perform measurements, report measurements, communicate control information or data, among other examples) in accordance with the SMTC or MG.

As indicated above, FIGS. 5A and 5B are provided as an example. Other examples may differ from what is described with respect to FIGS. 5A and 5B.

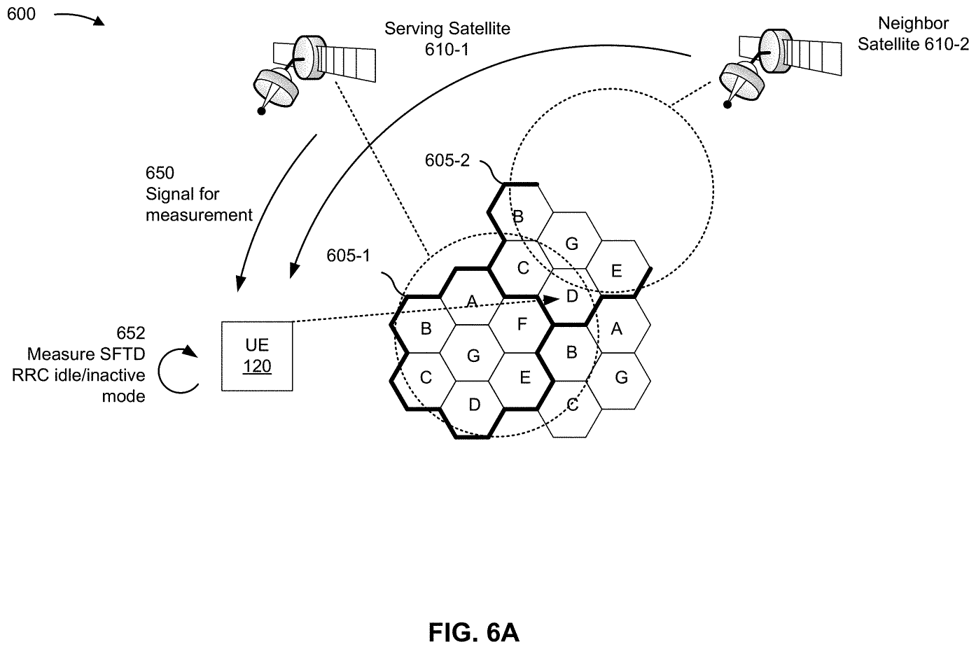

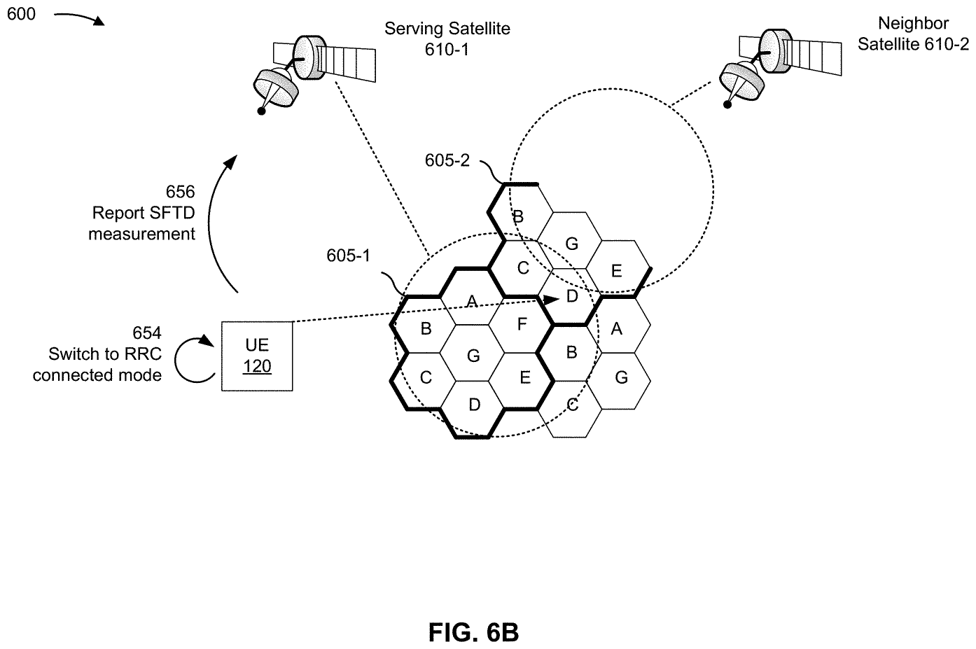

FIGS. 6A and 6B are diagram illustrating an example 600 associated with measurement in NTN deployments, in accordance with the present disclosure. As shown in FIGS. 6A and 6B, example 600 includes a UE 120 operating in FRF coverage areas 605 of a set of satellites 610. In some aspects, satellites 610 and UE 120 may be included in a wireless network, such as wireless network 100. Satellites 610 and UE 120 may communicate via a wireless access link, which may include an uplink and a downlink In some aspects, UE 120 may be in communication with one or more base stations 110 via the one or more satellites 610.

As further shown in FIG. 6A, and by reference number 650, satellites 610 may transmit one or more signals associated with one or more measurement resources. For example, serving satellite 610-1 may transmit a signal associated with a measurement resource at a first time, and neighbor satellite 610-2 may transmit a signal associated with a measurement resource at a second time. In some aspects, satellites 610 may transmit measurement resources associated with a particular set of measurements. For example, satellites 610 may transmit the measurement objects to identify measurement resources for an SSB measurement or a CSI-RS measurement, among other examples, to enable UE 120 to determine an SFTD.

As further shown in FIG. 6A, and by reference number 652, UE 120 may determine an SFTD (e.g., an inter-satellite cell measurement) from the measurement resources while in an RRC idle or inactive mode. For example, UE 120 may determine an SFTD measurement between a serving cell (e.g., of serving satellite 610-1) and a neighbor cell (e.g., of neighbor satellite 610-2 or of a base station 110, among other examples). In some aspects, UE 120 performs an SFTD measurement in an RRC idle or inactive mode based at least in part on broadcast information from a cell where UE 120 monitors a paging channel, a cell where UE 120 has been attached previously, or a dedicated configuration that had been provided by the previously attached cell. In some aspects, a timing at which UE 120 performs SFTD measurement in the RRC inactive or idle mode is based at least in part on a configuration of UE 120. For example, UE 120 may perform the SFTD measurement periodically or before transmitting a physical random access channel (PRACH) communication that triggers initial access procedure. Although some aspects are described in terms of an SFTD measurement, other types of time difference measurements are possible.

In some aspects, UE 120 may switch RRC modes before determining the SFTD measurement. For example, UE 120 may switch to an RRC inactive mode or an RRC idle mode before determining the SFTD measurement. In this case, UE 120 may achieve power savings by operating in the RRC inactive mode or RRC idle mode for a period of time relative to remaining in an RRC connected mode during the period of time. In some aspects, UE 120 may determine a time stamp associated with the SFTD measurement, as described above.

In some aspects, UE 120 may determine the target cells for the SFTD measurement based at least in part on received signaling For example, UE 120 may receive broadcast signaling identifying a set of target cells for which to perform the SFTD measurement. Additionally, or alternatively, UE 120 may determine the set of target cells for which to perform the SFTD measurement based at least in part on received information regarding one or more satellites 610, UE mobility information, or UE location information, among other examples. In some aspects, UE 120 may select a subset of cells for a satellite 610 for which to perform an SFTD measurement. For example, when neighbor satellite 610-2 is providing a plurality of cells, UE 120 may determine an RSRP for each of the plurality of cells and then select a single cell for which to report an SFTD measurement based at least in part on the RSRPs.

As further shown in FIG. 6B, and by reference number 654, UE 120 may switch to an RRC connected mode. For example, UE 120 may switch from the RRC inactive mode or the RRC idle mode to the RRC connected mode to enable a resumption of communication with serving satellite 610-1 or neighbor satellite 610-2, among other examples. In this case, UE 120 may store the SFTD measurement for transmission after a switch to the RRC connected mode.

As further shown in FIG. 6B, and by reference number 656, UE 120 may report the SFTD. For example, UE 120 may report the SFTD measurement using resources allocated to UE 120 for use in the RRC connected mode. In this case, UE 120 may report the SFTD measurement that was previously determined (e.g., before UE 120 entered the RRC connected mode). As described above, in another example, UE 120 may report a different time difference measurement. In this way, UE 120 reduces a time delay associated with reporting the SFTD measurement or another time difference measurement relative to performing a new SFTD measurement in the RRC connected mode and reporting the new SFTD measurement. Based at least in part on reducing the time delay associated with reporting the SFTD measurement, UE 120 enables configuration of an SMTC or MG for UE 120 with a reduced time delay, thereby improving network performance and/or reducing UE power consumption.

As indicated above, FIGS. 6A and 6B are provided as an example. Other examples may differ from what is described with respect to FIGS. 6A and 6B.

FIG. 7 is a diagram illustrating an example process 700 performed, for example, by a UE, in accordance with the present disclosure. Example process 700 is an example where the UE (e.g., UE 120) performs operations associated with measurement configuration in NTNs.

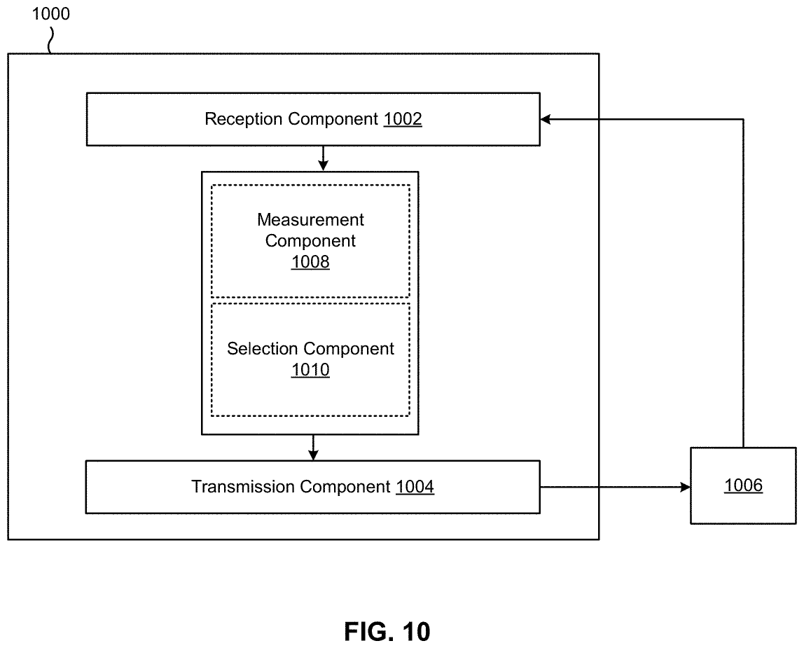

As shown in FIG. 7, in some aspects, process 700 may include receiving, from a source node in an NTN providing an NTN cell, measurement reference information regarding one or more measurements, wherein the measurement reference information includes association information including a group identifier for the one or more measurements (block 710). For example, the UE (e.g., using reception component 1002, depicted in FIG. 10) may receive, from a source node in an NTN providing an NTN cell, measurement reference information regarding one or more measurements, wherein the measurement reference information includes association information including a group identifier for the one or more measurements, as described above.

As further shown in FIG. 7, in some aspects, process 700 may include communicating in the NTN cell in accordance with the measurement reference information (block 720). For example, the UE (e.g., using transmission component 1004 and/or reception component 1002, depicted in FIG. 10) may communicate in the NTN cell in accordance with the measurement reference information, as described above.

Process 700 may include additional aspects, such as any single aspect or any combination of aspects described below and/or in connection with one or more other processes described elsewhere herein.

In a first aspect, the measurement reference information includes at least one of timing information or frequency information associated with a set of measurement objects.

In a second aspect, alone or in combination with the first aspect, the frequency information is Doppler shift information.

In a third aspect, alone or in combination with one or more of the first and second aspects, the measurement reference information is based at least in part on a synchronization associated with a common timing source.

In a fourth aspect, alone or in combination with one or more of the first through third aspects, the measurement reference information is based at least in part on a set of target measurement reference sources.

In a fifth aspect, alone or in combination with one or more of the first through fourth aspects, the set of target measurement reference sources includes at least one of a synchronization signal block or a channel state information reference signal.

In a sixth aspect, alone or in combination with one or more of the first through fifth aspects, the measurement reference information is based at least in part on at least one of a maximum reception time difference, or a timing alignment error.

In a seventh aspect, alone or in combination with one or more of the first through sixth aspects, the group identifier is at least one of an explicit group identifier, an implicit quasi co-location (QCL)-based identifier, a non-terrestrial source list, an inter-frequency cell list, an intra-frequency cell list, a measurement configuration parameter, or a system information parameter.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120) performs operations associated with measurement configuration in non-terrestrial networks.

As shown in FIG. 8, in some aspects, process 800 may include receiving, from a source node in an NTN providing an NTN cell, a request to provide timing information, wherein the timing information includes SFTD information and includes time stamp information (block 810). For example, the UE (e.g., using reception component 1002, depicted in FIG. 10) may receive, from a source node in a NTN providing an NTN cell, a request to provide timing information, wherein the timing information includes SFTD information and includes time stamp information, as described above.

As further shown in FIG. 8, in some aspects, process 800 may include communicating in the NTN cell in accordance with the timing information (block 820). For example, the UE (e.g., using transmission component 1004 and/or reception component 1002, depicted in FIG. 10) may communicate in the NTN cell in accordance with the timing information, as described above.

Process 800 may include additional aspects, such as any single aspect or any combination of aspects described below and/or in connection with one or more other processes described elsewhere herein.

In a first aspect, the time stamp information identifies a relative time offset from a slot in which the UE performed a measurement for the SFTD information.

In a second aspect, alone or in combination with the first aspect, the time stamp information identifies an index, of a time at which the UE performed a measurement for the SFTD information, within a configured time window.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120) performs operations associated with measurement configuration in non-terrestrial networks.

As shown in FIG. 9, in some aspects, process 900 may include performing, in an NTN providing an NTN cell, an inter-satellite cell measurement in a RRC idle or inactive mode (block 910). For example, the UE (e.g., using measurement component 1008, depicted in FIG. 10) may perform, in an NTN providing an NTN cell, an inter-satellite cell measurement in a RRC idle or inactive mode, as described above.

As further shown in FIG. 9, in some aspects, process 900 may include transmitting a report of the inter-satellite cell measurement in connection with a transition to an RRC connected mode (block 920). For example, the UE (e.g., using transmission component 1004, depicted in FIG. 10) may transmit a report of the inter-satellite cell measurement in connection with a transition to an RRC connected mode, as described above.

Process 900 may include additional aspects, such as any single aspect or any combination of aspects described below and/or in connection with one or more other processes described elsewhere herein.

In a first aspect, the inter-satellite cell measurement is an SFN and SFTD measurement between a set of inter-satellite cells.

In a second aspect, alone or in combination with the first aspect, the report includes time stamp information, wherein the time stamp information includes an indicator of a time at which the UE performed the SFTD measurement.

In a third aspect, alone or in combination with one or more of the first and second aspects, process 900 includes receiving a broadcast identifying a set of target cells for the inter-satellite cell measurement, and performing the inter-satellite cell measurement comprises performing the inter-satellite cell measurement on the set of target cells.

In a fourth aspect, alone or in combination with one or more of the first through third aspects, process 900 includes selecting a set of target cells for the inter-satellite cell measurement based at least in part on at least one of a UE location or a parameter of a satellite providing a target cell, and performing the inter-satellite cell measurement comprises performing the inter-satellite cell measurement on the set of target cells.

In a fifth aspect, alone or in combination with one or more of the first through fourth aspects, process 900 includes selecting a single cell from a particular satellite, that provides a plurality of cells, based at least in part on a plurality of measured reference signal received powers associated with the plurality of cells, and performing the inter-satellite cell measurement comprises performing the inter-satellite cell measurement on the single cell.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include one or more of a measurement component 1008 or a selection component 1010, among other examples.

In some aspects, the apparatus 1000 may be configured to perform one or more operations described herein in connection with FIGS. 4A-6B. Additionally, or alternatively, the apparatus 1000 may be configured to perform one or more processes described herein, such as process 700 of FIG. 7, process 800 of FIG. 8, process 900 of FIG. 9, or a combination thereof. In some aspects, the apparatus 1000 and/or one or more components shown in FIG. 10 may include one or more components of the UE described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described above in connection with FIG. 2. In some aspects, the transmission component 1004 may be co-located with the reception component 1002 in a transceiver.

The reception component 1002 may receive, from a source node in an NTN providing an NTN cell, measurement reference information regarding one or more measurements, wherein the measurement reference information includes association information including a group identifier for the one or more measurements. The reception component 1002 and/or the transmission component 1004 may communicate in the NTN cell in accordance with the measurement reference information.

The reception component 1002 may receive, from a source node in an NTN providing an NTN cell, a request to provide timing information, wherein the timing information includes SFTD information and includes time stamp information. The reception component 1002 and/or the transmission component 1004 may communicate in the NTN cell in accordance with the timing information.

The measurement component 1008 may perform, in an NTN providing an NTN cell, an inter-satellite cell measurement in a RRC idle or inactive mode. The transmission component 1004 may transmit a report of the inter-satellite cell measurement in connection with a transition to an RRC connected mode.

The reception component 1002 may receive a broadcast identifying a set of target cells for the inter-satellite cell measurement. The selection component 1010 may select a set of target cells for the inter-satellite cell measurement based at least in part on at least one of a UE location or a parameter of a satellite providing a target cell. The selection component 1010 may select a single cell from a particular satellite, that provides a plurality of cells, based at least in part on a plurality of measured reference signal received powers associated with the plurality of cells.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

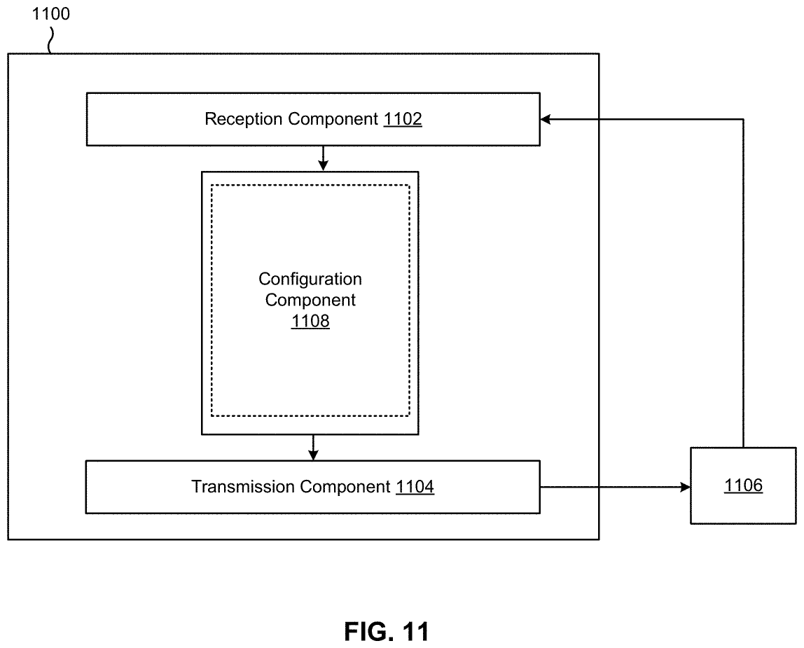

FIG. 11 is a block diagram of an example apparatus 1100 for wireless communication. The apparatus 1100 may be a satellite, or a satellite may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a configuration component 1108, among other examples.

In some aspects, the apparatus 1100 may be configured to perform one or more operations described herein in connection with FIGS. 4A-6B. Additionally, or alternatively, the apparatus 1100 may be configured to perform one or more processes described herein. In some aspects, the apparatus 1100 and/or one or more components shown in FIG. 11 may include one or more components of the satellite described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the satellite described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the satellite described above in connection with FIG. 2. In some aspects, the transmission component 1104 may be co-located with the reception component 1102 in a transceiver.

The configuration component 1108 may configure a measurement object, a measurement configuration, or an SMTC or MG, among other examples.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving, from a source node in an NTN providing an NTN cell, measurement reference information regarding one or more measurements, wherein the measurement reference information includes association information including a group identifier for the one or more measurements; and communicating in the NTN cell in accordance with the measurement reference information.

Aspect 2: The method of Aspect 1, wherein the measurement reference information includes at least one of timing information or frequency information associated with a set of measurement objects.

Aspect 3: The method of Aspect 2, wherein the frequency information is Doppler shift information.

Aspect 4: The method of any of Aspects 1 to 3, wherein the measurement reference information is based at least in part on a synchronization associated with a common timing source.

Aspect 5: The method of any of Aspects 1 to 4, wherein the measurement reference information is based at least in part on a set of target measurement reference sources.

Aspect 6: The method of Aspect 5, wherein the set of target measurement reference sources includes at least one of: a synchronization signal block, or a channel state information reference signal.

Aspect 7: The method of any of Aspects 1 to 6, wherein the measurement reference information is based at least in part on at least one of: a maximum reception time difference, or a timing alignment error.

Aspect 8: The method of any of Aspects 1 to 7, wherein the group identifier is at least one of: an explicit group identifier, an implicit QCL-based identifier, a non-terrestrial source list, an inter-frequency cell list, an intra-frequency cell list, a measurement configuration parameter, or a system information parameter.

Aspect 9: A method of wireless communication performed by a UE, comprising: receiving, from a source node in an NTN providing an NTN cell, a request to provide timing information, wherein the timing information includes SFTD information and includes time stamp information; and communicating in the NTN cell in accordance with the timing information.

Aspect 10: The method of Aspect 9, wherein the time stamp information identifies a relative time offset from a slot in which the UE performed a measurement for the SFTD information.

Aspect 11: The method of any of Aspects 9 to 10, wherein the time stamp information identifies an index, of a time at which the UE performed a measurement for the SFTD information, within a configured time window.

Aspect 12: A method of wireless communication performed by a UE, comprising: performing, in an NTN providing an NTN cell, an inter-satellite cell measurement in a radio resource control (RRC) idle or inactive mode; and transmitting a report of the inter-satellite cell measurement in connection with a transition to an RRC connected mode.

Aspect 13: The method of Aspect 12, wherein the inter-satellite cell measurement is a SFTD measurement between a set of inter-satellite cells.

Aspect 14: The method of Aspect 13, wherein the report includes time stamp information, wherein the time stamp information includes an indicator of a time at which the UE performed the SFTD measurement.

Aspect 15: The method of any of Aspects 12 to 14, further comprising: receiving a broadcast identifying a set of target cells for the inter-satellite cell measurement; and wherein performing the inter-satellite cell measurement comprises: performing the inter-satellite cell measurement on the set of target cells. wherein performing the inter-satellite cell measurement comprises performing the inter-satellite cell measurement on the set of target cells.

Aspect 16: The method of any of Aspects 12 to 15, further comprising: selecting a set of target cells for the inter-satellite cell measurement based at least in part on at least one of a UE location or a parameter of a satellite providing a target cell; and wherein performing the inter-satellite cell measurement comprises: performing the inter-satellite cell measurement on the set of target cells. wherein performing the inter-satellite cell measurement comprises performing the inter-satellite cell measurement on the set of target cells.

Aspect 17: The method of any of Aspects 12 to 16, further comprising: selecting a single cell from a particular satellite, that provides a plurality of cells, based at least in part on a plurality of measured reference signal received powers associated with the plurality of cells; and wherein performing the inter-satellite cell measurement comprises: performing the inter-satellite cell measurement on the single cell. wherein performing the inter-satellite cell measurement comprises performing the inter-satellite cell measurement on the single cell.

Aspect 18: An apparatus for wireless communication at a device, comprising a processor; memory coupled with the processor; and instructions stored in the memory and executable by the processor to cause the apparatus to perform the method of one or more of Aspects 1-8.

Aspect 19: A device for wireless communication, comprising a memory and one or more processors coupled to the memory, the one or more processors configured to perform the method of one or more of Aspects 1-8.

Aspect 20: An apparatus for wireless communication, comprising at least one means for performing the method of one or more of Aspects 1-8.

Aspect 21: A non-transitory computer-readable medium storing code for wireless communication, the code comprising instructions executable by a processor to perform the method of one or more of Aspects 1-8.

Aspect 22: A non-transitory computer-readable medium storing a set of instructions for wireless communication, the set of instructions comprising one or more instructions that, when executed by one or more processors of a device, cause the device to perform the method of one or more of Aspects 1-8.

Aspect 23: An apparatus for wireless communication at a device, comprising a processor; memory coupled with the processor; and instructions stored in the memory and executable by the processor to cause the apparatus to perform the method of one or more of Aspects 9-11.

Aspect 24: A device for wireless communication, comprising a memory and one or more processors coupled to the memory, the one or more processors configured to perform the method of one or more of Aspects 9-11.

Aspect 25: An apparatus for wireless communication, comprising at least one means for performing the method of one or more of Aspects 9-11.

Aspect 26: A non-transitory computer-readable medium storing code for wireless communication, the code comprising instructions executable by a processor to perform the method of one or more of Aspects 9-11.

Aspect 27: A non-transitory computer-readable medium storing a set of instructions for wireless communication, the set of instructions comprising one or more instructions that, when executed by one or more processors of a device, cause the device to perform the method of one or more of Aspects 9-11.

Aspect 28: An apparatus for wireless communication at a device, comprising a processor; memory coupled with the processor; and instructions stored in the memory and executable by the processor to cause the apparatus to perform the method of one or more of Aspects 12-17.

Aspect 29: A device for wireless communication, comprising a memory and one or more processors coupled to the memory, the one or more processors configured to perform the method of one or more of Aspects 12-17.

Aspect 30: An apparatus for wireless communication, comprising at least one means for performing the method of one or more of Aspects 12-17.

Aspect 31: A non-transitory computer-readable medium storing code for wireless communication, the code comprising instructions executable by a processor to perform the method of one or more of Aspects 12-17.

Aspect 32: A non-transitory computer-readable medium storing a set of instructions for wireless communication, the set of instructions comprising one or more instructions that, when executed by one or more processors of a device, cause the device to perform the method of one or more of Aspects 12-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b +b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a source node in a non-terrestrial network (NTN) providing an NTN cell, measurement reference information regarding one or more measurements, wherein the measurement reference information includes association information including a group identifier for the one or more measurements; and
communicate in the NTN cell in accordance with the measurement reference information.

2. The UE of claim 1, wherein the measurement reference information includes at least one of timing information or frequency information associated with a set of measurement objects.

3. The UE of claim 2, wherein the frequency information is Doppler shift information.

4. The UE of claim 1, wherein the measurement reference information is based at least in part on a synchronization associated with a common timing source.

5. The UE of claim 1, wherein the measurement reference information is based at least in part on a set of target measurement reference sources.

6. The UE of claim 5, wherein the set of target measurement reference sources includes at least one of:
a synchronization signal block, or
a channel state information reference signal

7. The UE of claim 1, wherein the measurement reference information is based at least in part on at least one of:
a maximum reception time difference, or
a timing alignment error.

8. The UE of claim 1, wherein the group identifier is at least one of:
an explicit group identifier,
an implicit quasi co-location (QCL)-based identifier,
a non-terrestrial source list,
an inter-frequency cell list,
an intra-frequency cell list,
a measurement configuration parameter, or
a system information parameter.

9. A user equipment (UE) for wireless communication, comprising:
a memory; and
one or more processors, coupled to the memory, configured to:
receive, from a source node in a non-terrestrial network (NTN) providing an NTN cell, a request to provide timing information, wherein the timing information includes system frame number (SFN) or system frame timing difference (SFTD) information and includes time stamp information; and
communicate in the NTN cell in accordance with the timing information.

10. The UE of claim 9, wherein the time stamp information identifies a relative time offset from a slot in which the UE performed a measurement for the SFTD information.

11. The UE of claim 9, wherein the time stamp information identifies an index, of a time at which the UE performed a measurement for the SFTD information, within a configured time window.

12. A user equipment (UE) for wireless communication, comprising:
a memory; and
one or more processors, coupled to the memory, configured to:
perform, in a non-terrestrial network (NTN) providing an NTN cell, an inter-satellite cell measurement in a radio resource control (RRC) idle or inactive mode; and
transmit a report of the inter-satellite cell measurement in connection with a transition to an RRC connected mode.

13. The UE of claim 12, wherein the inter-satellite cell measurement is a system frame number (SFN) or system frame timing difference (SFTD) measurement between a set of inter-satellite cells.

14. The UE of claim 13, wherein the report includes time stamp information, wherein the time stamp information includes an indicator of a time at which the UE performed the SFTD measurement.

15. The UE of claim 12, wherein the one or more processors are further configured to:
receive a broadcast identifying a set of target cells for the inter-satellite cell measurement; and
wherein the UE, when performing the inter-satellite cell measurement, is configured to:
perform the inter-satellite cell measurement on the set of target cells.

16. The UE of claim 12, wherein the one or more processors are further configured to:
select a set of target cells for the inter-satellite cell measurement based at least in part on at least one of a UE location or a parameter of a satellite providing a target cell; and
wherein the UE, when configured to perform the inter-satellite cell measurement, is configured to:
perform the inter-satellite cell measurement on the set of target cells.

17. The UE of claim 12, wherein the one or more processors are further configured to:
select a single cell from a particular satellite, that provides a plurality of cells, based at least in part on a plurality of measured reference signal received powers associated with the plurality of cells; and
wherein the UE, when configured to perform the inter-satellite cell measurement, is configured to:
perform the inter-satellite cell measurement on the single cell.

18. A method of wireless communication performed by a user equipment (UE), comprising:
receiving, from a source node in a non-terrestrial network (NTN) providing an NTN cell, measurement reference information regarding one or more measurements, wherein the measurement reference information includes association information including a group identifier for the one or more measurements; and
communicating in the NTN cell in accordance with the measurement reference information.

19. The method of claim 18, wherein the measurement reference information includes at least one of timing information or frequency information associated with a set of measurement objects.

20. The method of claim 19, wherein the frequency information is Doppler shift information.

21. The method of claim 18, wherein the measurement reference information is based at least in part on a synchronization associated with a common timing source.

22. The method of claim 18, wherein the measurement reference information is based at least in part on a set of target measurement reference sources.

23. The method of claim 22, wherein the set of target measurement reference sources includes at least one of:
a synchronization signal block, or
a channel state information reference signal

24. The method of claim 18, wherein the measurement reference information is based at least in part on at least one of:
a maximum reception time difference, or
a timing alignment error.

25. The method of claim 18, wherein the group identifier is at least one of:
an explicit group identifier,
an implicit quasi co-location (QCL)-based identifier,
a non-terrestrial source list,
an inter-frequency cell list,
an intra-frequency cell list,
a measurement configuration parameter, or
a system information parameter.
